(19) United States
(12) Patent Application Publication
(10) Pub. No.: US 2014/0115038 A1
(43) Pub. Date: Apr. 24, 2014

(54) SERVER AND METHOD FOR DISTRIBUTING FILES

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHI-QUAN CHAI, Shenzhen (CN); DA-PENG LI, Shenzhen (CN); HAI-HONG LIN, Shenzhen (CN); CHUNG-I LEE, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/055,916

(22) Filed: Oct. 17, 2013

(30) Foreign Application Priority Data
Oct. 24, 2012 (CN) 2012104101854

(51) Int. Cl. H04L 29/08; H04L 29/06

(52) U.S. Cl. CPC H04L 29/08117; H04L 29/06047
USPC 709/203

(57) ABSTRACT

In a method for distributing files, a size of the file is read. The file is transmitted to a whole file server in response that the size of the file does not exceed a preset value. A file header data of the file is read and format information of the file is acquired from the file header data, in response that the size of the file exceeds the preset value. A chunking technology for dividing the file is determined according to the format of the file. If a FSP technology is suitable for the file, the file is transmitted to a FSP server. If a CDC technology is suitable for the file, the file is transmitted to a CDC server. If a SB technology is suitable for the file, the file is transmitted to a SB server.

### BACKGROUND

1. Technical Field

Embodiments of the present disclosure generally relate to data processing technology, and particularly to a server and a method for distributing files.

2. Description of Related Art

Files may be divided into chunks, to execute data de-duplication processing on the files. If the files are photos or music, a fixed-sized partition (FSP) technology may be applied to divide the files. If the files are a CD mirror or a system backup, a content-defined chunking (CDC) technology may be applied to divide the files. If the files are in WORD or EXCEL format, a sliding block (SB) technology may be applied to divide the files. However, there is no technology which is suitable for all types of the files. So it is needed to find out a type of a file before dividing the file.

### BRIEF DESCRIPTION OF THE DRAWINGS

FIG. 1 is a schematic diagram of one embodiment of a management server.

FIG. 2 is a block diagram of one embodiment of function modules of a management unit of the management server in FIG. 1.

FIG. 3 is a flowchart of one embodiment of a method for distributing files using the management server of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

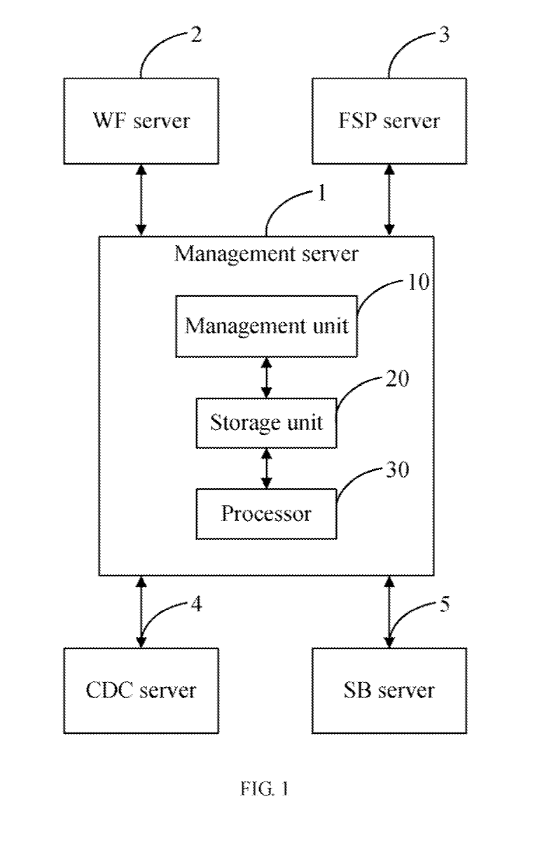

FIG. 1 is a schematic diagram of one embodiment of a management server 1. In the embodiment, the management server 1 includes a management unit 10, a storage unit 20, and a processor 30. The management server 1 is electronically connected to more than one servers, including a whole file (WF) server 2, a fixed-sized partition (FSP) server 3, a content-defined chunking (CDC) server 4, and a sliding block (SB) server 5. The management server 1 distributes files to the servers 2-5 according to a size and a format of the file.

The WF server 2 is suitable to execute data de-duplication processing on a whole file, such as an e-book file, which has a small size and data de-duplication processing can be performed on the file without dividing the file. The FSP server 3 divides a file into chunks by the FSP technology, and data de-duplication processing can be performed on the file based on the chunks. The FSP server 3 is suitable to divide a non-editable file having a big size, such as a photo, a film, or a music. The CDC server 4 divides a file into chunks by the CDC technology, and data de-duplication processing can be performed on the file based on the chunks. The CDC server 4 is suitable to divide a file having a big size, where the file is editable and is less possible to be edited by users, such as a CD mirror or a personal work. The SB server 5 divides a file into chunks by the SB technology, and data de-duplication processing can be performed on the file based on the chunks. The SB server 5 is suitable to divide a file which has a big size, where the file is editable and is more possible to be edited by users, such as a large software program on making or a video on editing and rearrangement.

In the embodiment, the management server 1, the WF server 2, the FSP server 3, the CDC server 4, and the SB server 5 may be in a cloud storage system. In other embodiments, the WF server 2, the FSP server 3, the CDC server 4, and the SB server 5 may be merged with the management server 1.

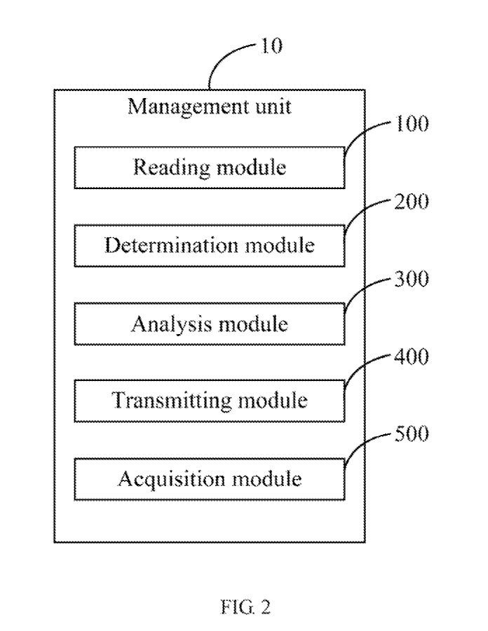

In one embodiment, the management unit 10 may include one or more function modules (as shown in FIG. 2). The one or more function modules may comprise computerized code in the form of one or more programs that are stored in the storage unit 20, and executed by the processor 30 to provide the functions of the management unit 10. The storage unit 20 is a dedicated memory, such as an EPROM or a flash memory.

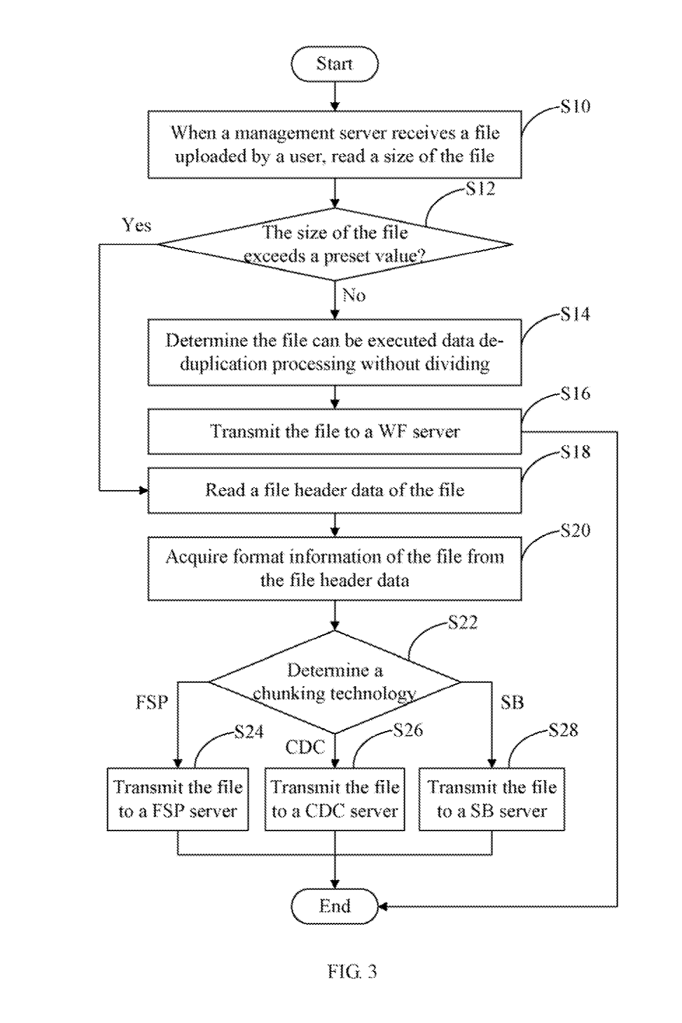

FIG. 2 is a block diagram of one embodiment of the function modules of the management unit 10. In one embodiment, the management unit 10 includes a reading module 100, a determination module 200, an analysis module 300, a transmitting module 400, and an acquisition module 500. A description of the functions of the modules 100-500 is given with reference to FIG. 3.

FIG. 3 is a flowchart of one embodiment of a method for distributing the files. Depending on the embodiment, additional steps may be added, others removed, and the ordering of the steps may be changed, all steps are labeled with even numbers only.

In step S10, when the management server 1 receives a file uploaded by a user, the reading module 100 reads a size of the file. In the embodiment, the reading module 100 may read an attribute of the file by a function “fstat( )”, and the attribute of the file includes the size of the file.

In step S12, the determination module 200 determines whether the size of the file exceeds a preset value, for example, 512K Byte. If the size of the file exceeds the preset value, steps S18-S28 are implemented. If the size of the file does not exceed the preset value, steps S14-S16 are implemented.

In step S14, the analysis module 300 determines that the file can be executed data de-duplication processing without dividing.

In step S16, the transmitting module 400 transmits the file to the WF server 2. The WF server 2 executes the data de-duplication processing on the whole file.

In step S18, the reading module 100 reads a file header data of the file. In the embodiment, the reading module 100 reads the file header data of the file by a function “read( )”. The file header data is hexadecimal, and is the first sixteen bits data of the file. For example, if the file is in a JPG format, the first sixteen bits data of the file “FF D8 FF E0 00 10 4A 46 49 46 00 01 01 00 00 01”, are the file header data of the file.

In step S20, the acquisition module 600 acquires format information of the file from the file header data. For example, if the file is in a JPG format, the first three bits of the file header data “FF D8 FF” represents the format “JPG”. Furthermore, the first four bits “89 50 4E 47” of the file header data represents a format “PNG”; the first five bits “47 3C 3F 78 6D 6C” of the file header data represents a format “XML”; the first four bits “D0 CF 11 E0” of the file header data represents a format “XLS” or “DOC”.

In step S22, the analysis module 300 determines a chunking technology corresponding to the file, according to the format of the file. In the embodiment, the chunking technology includes the FSP technology, the CDC technology, and the SB technology. If the file is not editable, for example, if the file is in an AVI, MP3, or RAR format, the FSP technology is suitable for the file, then step S24 is implemented. If the file is editable and is less possible to be edited by users, for example, if the file is in an IOS or BAK format, the CDC technology is suitable for the file, then step S26 is implemented. If the file is editable and is more possible to be edited by users, for example, if the file is in a DOC or XLS format, the SB technology is suitable for the file, then step S28 is implemented.

In step S24, the transmitting module 400 transmits the file to the FSP server 3. The FSP server 3 divides the file into chunks by the FSP technology, and executes the data de-duplication processing on the file based on the chunks.

In step S26, the transmitting module 400 transmits the file to the CDC server 4. The CDC server 4 divides the file into chunks by the CDC technology, and executes the data de-duplication processing on the file based on the chunks.

In step S28, the transmitting module 400 transmits the file to the SB server 5. The SB server 5 divides the file into chunks by the SB technology, and executes the data de-duplication processing on the file based on the chunks.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method being executed by a processor of a server electronically connected to a whole file (WF) server, a fixed-sized partition (FSP) server, a content-defined chunking (CDC) server, and a sliding block (SB) server, the method comprising:
(a) reading a size of a file received from a client;
(b) transmitting the file to the WF server, in response that the size of the file does not exceed a preset value, or reading a file header data of the file, in response that the size of the file exceeds the preset value;
(c) acquiring format information of the file from the file header data; and
(d) determining a chunking technology for dividing the file according to the format of the file, and transmitting the file to one of the FSP server, the CDS server, and the SB server according to the determined chunking technology.

2. The method as claimed in claim 1, wherein step (d) comprises:
determining that the FSP technology is suitable for the file in response that the file is not editable;
determining that the CDC technology is suitable for the file in response that the file is editable and is less possible to be edited; or
determining that the SB technology is suitable for the file in response that the file is editable and is more possible to be edited.

3. The method as claimed in claim 2, wherein step (d) further comprises:
transmitting the file to the FSP server in response to determining that a FSP technology is suitable for the file;
transmitting the file to the CDC server in response to determining that a CDC technology is suitable for the file; and
transmitting the file to the SB server in response to determining that a SB technology is suitable for the file.

4. A non-transitory storage medium storing a set of instructions, the set of instructions being executed by a processor of a server electronically connected to a whole file (WF) server, a fixed-sized partition (FSP) server, a content-defined chunking (CDC) server, and a sliding block (SB) server, to perform a method comprising:
(a) reading a size of a file received from a client;
(b) transmitting the file to the WF server, in response that the size of the file does not exceed a preset value, or reading a file header data of the file, in response that the size of the file exceeds the preset value;
(c) acquiring format information of the file from the file header data; and
(d) determining a chunking technology for dividing the file according to the format of the file, and transmitting the file to one of the FSP server, the CDS server, and the SB server according to the determined chunking technology.

5. The non-transitory storage medium as claimed in claim 4, wherein step (d) comprises:
determining that the FSP technology is suitable for the file in response that the file is not editable;
determining that the CDC technology is suitable for the file in response that the file is editable and is less possible to be edited; or
determining that the SB technology is suitable for the file in response that the file is editable and is more possible to be edited.

6. The non-transitory storage medium as claimed in claim 5, wherein step (d) further comprises:
transmitting the file to the FSP server in response to determining that a FSP technology is suitable for the file;
transmitting the file to the CDC server in response to determining that a CDC technology is suitable for the file; and
transmitting the file to the SB server in response to determining that a SB technology is suitable for the file.

7. A server electronically connected to a whole file (WF) server, a fixed-sized partition (FSP) server, a content-defined chunking (CDC) server, and a sliding block (SB) server, the server comprising:
at least one processor; and
a storage unit storing one or more programs, which when executed by the at least one processor, causes the at least one processor to:
read a size of a file received from a client;
transmit the file to the WF server, in response that the size of the file does not exceed a preset value, or read a file header data of the file, in response that the size of the file exceeds the preset value;
acquire format information of the file from the file header data; and
determine a chunking technology for dividing the file according to the format of the file, and transmit the file to one of the FSP server, the CDS server, and the SB server according to the determined chunking technology.

8. The server as claimed in claim 7, wherein the chunking technology comprises the FSP technology, the CDC technology, and the SB technology;
the FSP technology is suitable for the file that is not editable;
the CDC technology is suitable for the file that is editable and is less possible to be edited;
the SB technology is suitable for the file that is editable and is more possible to be edited.

9. The server as claimed in claim 8, wherein the at least one processor:
transmits the file to the FSP server in response to determining that a FSP technology is suitable for the file;
transmits the file to the CDC server in response to determining that a CDC technology is suitable for the file; and
transmits the file to the SB server in response to determining that a SB technology is suitable for the file.
